(19) United States
(12) Patent Application Publication
(10) Pub. No.: US 2017/0013578 A1
(43) Pub. Date: Jan. 12, 2017

(54) SYNCHRONIZATION METHOD FOR A DEVICE-TO-DEVICE DISCOVERY AND/OR A DEVICE-TO-DEVICE COMMUNICATION, USER EQUIPMENT, AND SYNCHRONIZATION CONTROL UNIT

(71) Applicant: Sony Corporation, Tokyo (JP)

(72) Inventors: Na Wei, Beijing (CN); Feng Chen, Beijing (CN); Dahai Liu, Beijing (CN); Yong Zhao, Beijing (CN); Anders Berggren, Lund (SE)

(21) Appl. No.: 15/113,582

(22) PCT Filed: Jul. 30, 2014
(86) PCT No.: PCT/IB2014/063536

§ 371 Date: Jul. 22, 2016

(30) Foreign Application Priority Data
Jan. 29, 2014 (CN) 201410110625.3

(51) Int. Cl. H04W 56/00; H04W 76/02; H04W 8/00

(52) U.S. Cl. CPC H04W 56/0015; H04W 8/005; H04W 76/023

(57) ABSTRACT

To attain a synchronization for a device-to-device discovery and/or a device-to-device communication, a user equipment determines whether it is enabled to transmit a synchronization signal (65) for the device-to-device discovery and/or the device-to-device communication The user equipment has a wireless interface configured for communication with a radio access network of a mobile communication network. The user equipment selectively transmits the synchronization signal (65) for the futflled device-to-device discovery and/or the device-to-device communication over the wireless interface to at least one further user equipment.

### TECHNICAL FIELD

Embodiments of the invention relate to mobile communication systems. Embodiments of the invention relate in particular to synchronization techniques for device-to-device discovery and/or device-to-device communication in mobile communication networks.

### BACKGROUND ART

The demand for mobile data and voice communication continues to evidence significant growth. Examples for mobile communication systems include cellular-based wireless communication networks. Such networks include various network nodes. The network nodes may include base stations which respectively provide coverage for a radio cell.

A user equipment of a mobile communication network may be a Proximity Service (ProSe) enabled device. Several ProSe enabled user equipments which are located in proximity to each other are operative to perform device-to-device (D2D) communication. D2D communication allows user equipments of a mobile communication network to directly communicate with each other when the user equipments are located in proximity to each other. D2D communication has a wide variety of applications, including public safety and other use cases. Emergency calls are one example for public safety use cases of D2D communication. Direct data or voice communication between user equipments is another example for use cases of D2D communication. For illustration, ProSe enabled user equipments located in proximity to each other may engage in data or voice communication.

In order to perform D2D communication, a user equipment must be capable of detecting one or several other user equipments which are located in proximity to the user equipment. To this end, the user equipment performs a D2D discovery.

Synchronization between user equipments may be required for D2D communication and/or D2D discovery. One synchronization technique which could be contemplated is that each user equipment which is ProSe enabled transmits synchronization signals. Such an approach may be associated with various drawbacks. Signaling on the air interface may increase. Further, a receiver may experience a superposition of various synchronization signals, which may be identical or which may be slightly shifted in the frequency domain due to Doppler spread. This may cause difficulties in processing the synchronization signals, in addition to the increased traffic load on the air interface.

### SUMMARY

There is a need in the art for synchronization techniques for a device-to-device discovery and/or a device-to-device communication which mitigate at least some of the above shortcomings. There is in particular a need for such techniques which can be implemented without significant signaling overhead on the air interface. There is also a need for such techniques in which a synchronization control unit, which may be configured as a base station of a mobile communication network or a group head of a device-to-device communication group, has some degree of control over the transmission of synchronization signals.

According to exemplary embodiments of the invention, a user equipment may selectively transmit a synchronization signal for a device-to-device discovery and/or a device-to-device communication depending on whether it is enabled to do so. The synchronization signal for the device-to-device discovery and/or the device-to-device communication will be referred to as “D2DSS” (device-to-device synchronization signal) in the following, it being understood that the D2DSS may be used only for device-to-device (D2D) discovery, only for D2D communication, or for both D2D discovery and D2D communication.

When a user equipment is enabled to transmit the D2DSS, it transmits the D2DSS to at least one further user equipment via a wireless interface which is configured to also communicate with a radio access network of a mobile communication network.

The user equipment may be enabled to transmit the D2DSS in various ways. The user equipment may evaluate whether criteria are fulfilled. The criteria may be temporarily or persistently stored at the user equipment, and the user equipment may evaluate the criteria to determine whether it is enabled to transmit the D2DSS. Input parameters for evaluating the criteria may include time, location, battery level, or other parameters available locally at the user equipment. The user equipment may alternatively or additionally request a base station of the mobile communication network or a group head of a D2D communication group to authorize the user equipment to transmit the D2DSS. The base station or the group head may transmit a message to the user equipment to enable the transmission of the D2DSS.

The user equipment may transmit the D2DSS with a timing which is referenced to a synchronization source. The user equipment may perform a synchronization source reselection procedure to reference the transmission to the D2DSS to a further, i.e. new, synchronization source.

In the various embodiments, the transmission of the D2DSS does not need to be performed by all devices included in a D2D communication group. Traffic on the air interface which is associated with the synchronization may be kept moderate.

A method according to an embodiment is used for synchronization for D2D discovery and/or D2D communication. In the method, a user equipment determines, whether it is enabled to transmit a D2DSS. The user equipment has a wireless interface configured for communication with a radio access network of a mobile communication network. The user equipment selectively transmits the D2DSS over the wireless interface to at least one further user equipment. This allows the user equipment to be selectively enabled for transmitting the D2DSS, thereby providing control over the transmission of the D2DSS and reducing traffic loads on the air interface.

The user equipment may determine whether criteria stored at the user equipment are fulfilled. The user equipment may transmit the D2DSS depending on a result of an evaluation of the criteria. This allows the user equipment to take decisions regarding the transmission of the D2DSS, e.g. in cases in which the user equipment is out of coverage of the mobile communication network. The criteria may have various input parameters which are determined locally at the user equipment. The input parameters may include any one or any combination of a time, a location of the user equipment, power available at the user equipment, signal quality of received signals.

The user equipment may stop transmitting the D2DSS when the criteria are no longer fulfilled. This allows the user equipment to automatically stop the transmission of the D2DSS, depending on at least one reselection criterion which can be verified locally at the user equipment.

The user equipment may receive a signaling at the wireless interface which configures the criteria. This allows the mobile communication network or a group head of a D2D communication group to configure the criteria in the user equipment. Control of the transmission of the D2DSS is improved.

The user equipment may receive the signaling which configures the criteria from a base station of the mobile communication network or a group head of a device-to-device communication group. The user equipment may receive the signaling which configures the criteria in a Radio Resource Control (RRC) signaling or a beacon transmitted by the base station or the group head. Thereby, the criteria can be configured in the user equipment while using RRC signaling or beacons which are transmitted over the air interface at any rate. The criteria may be configured using signaling on layer 1 or on layer 2.

The criteria may include any one or any combination of the following: The user equipment has needs to perform D2D, but does not receive a D2DSS at the wireless interface; a signal quality indicator, e.g. a signal-to-noise ratio (SNR) of a D2DSS received at the wireless interface is less than a threshold; the signal quality indicator, e.g. a signal-to-noise ratio (SNR) of a D2DSS received at the wireless interface is greater than a further threshold; a speed at which the user equipment moves is lower than a speed threshold; and/or the user equipment is not engaged in a cell selection or handover procedure.

The user equipment may transmit a request to a base station of the mobile communication network or to a group head of a device-to-device communication group if the criteria are fulfilled. Thereby, the base station or the group head can be informed that the user equipment intends to start transmitting the D2DSS.

The user equipment may receive a message from the base station or the group head, which authorizes the user equipment to transmit the D2DSS. The user equipment may receive the message in response to transmitting the request. The user equipment may transmit the D2DSS in response to receiving the message. Thereby, the base station or the group head can be provided with control over the transmission of the D2DSS. The base station or the group head can decide, e.g. based on traffic loads and/or available resources, whether the user equipment is enabled to transmit the D2DSS by transmission of the message.

The user equipment may receive the message from the base station or the group head even if the user equipment has not previously transmitted the request. The base station or the group head may transmit the message which authorizes the user equipment to transmit the D2DSS. This may occur when a further user equipment different from the user equipment requests the base station or group head to initiate transmission of the D2DSS by the user equipment, for example.

The user equipment may transmit a request to a base station of the mobile communication network or to a group head of a device-to-device communication group, even if no criteria for transmitting the D2DSS are configured at the user equipment. The user equipment may receive a message from the base station or the group head which authorizes the user equipment to transmit the D2DSS. The base station or the group head can decide, e.g. based on traffic loads and/or available resources, whether the user equipment is enabled to transmit the D2DSS by transmission of the message.

If the user equipment determines that no base station of the mobile communication network and/or no group head of a device-to-device communication group is available for authorizing the user equipment to transmit the D2DSS, the user equipment may evaluate the criteria at the user equipment in a fallback procedure to determine whether the user equipment is enabled to transmit the D2DSS.

If the user equipment does not receive a message which authorizes the transmission of the D2DSS, the user equipment may evaluate the criteria at the user equipment in a fallback procedure to determine whether the user equipment is enabled to transmit the D2DSS.

The user equipment may transmit the D2DSS in response to receiving the message. Thereby, the base station or the group head can be provided with control over the transmission of the D2DSS.

The user equipment may retrieve at least one parameter included in the message. The parameter may define any one, or any combination of, a validity duration, a power setting for transmitting the D2DSS, and/or a validity area. Thereby, the base station or the group head may influence the transmission of the D2DSS by the user equipment.

The user equipment may selectively transmit the D2DSS as a function of the at least one parameter. The user equipment may transmit the D2DSS depending on whether the validity time has already expired and/or whether the user equipment is located within the validity area.

The request transmitted by the user equipment may include information on a cause of the request. The cause may indicate whether the request is triggered by a public safety need, such as an emergency communication. The request may include information on a synchronization source or on changes of a synchronization source against which the transmission of the D2DSS is synchronized. The request may include information on a power capability or power preferences of the user equipment. The request may include information on a location of the user equipment.

The user equipment may be synchronized to a synchronization source.

The user equipment may transmit the D2DSS with a timing which is referenced to a synchronization source. To this end, the user equipment may first scan for a synchronization source. If a synchronization source is available, the user equipment may use the synchronization source as a reference for transmitting the D2DSS.

The user equipment may perform a synchronization source reselection. This allows the user equipment to use another reference for transmitting the D2DSS, e.g., when a synchronization source having higher priority becomes available.

The synchronization source reselection may comprise identifying, by the user equipment, a further synchronization source which is preferred over the synchronization source based on at least one reselection criterion. The at least one reselection criterion may depend on at least one of a priority of the synchronization source and a priority of the further synchronization source. The at least one reselection criterion may depend on at least one of a signal quality of the synchronization source and a signal quality of the further synchronization source.

A further synchronization source which is a base station may be preferred over a synchronization source which is not a base station. A further synchronization source which is an other user equipment located within a coverage area of the mobile communication network may be preferred over a synchronization source which is not located within the coverage area of the mobile communication network.

The synchronization source reselection may be performed when a predefined time interval expires. The predefined time interval may be triggered by the selection of the synchronization source. Expiry of the predefined time interval may cause the user equipment to automatically perform the synchronization source reselection.

The synchronization source reselection may comprise receiving, by the user equipment, a reselection message from a base station of the mobile communication network or from a group head of a device-to-device communication group. The user equipment may perform the synchronization source reselection in response to receiving the reselection message. This provides the base station or the group head with control over the synchronization source reselection.

The synchronization source reselection may comprise transmitting, by the user equipment, a reselection request to the base station or to the group head. The user equipment may receive the reselection message in response to transmitting the reselection request. Thereby, the user equipment may cause the base station or the group head to transmit the reselection message.

The reselection request may include information on the synchronization source which has previously been used as reference for transmitting the D2DSS, and/or information on the further synchronization source which shall be used as reference for transmitting the D2DSS in the future.

According to another embodiment, a user equipment is provided. The user equipment comprises a wireless interface configured to communicate with a mobile communication network. The user equipment comprises a processing device coupled to the wireless interface. The processing device is configured to determine whether the user equipment is enabled to transmit a D2DSS. The processing device is configured to control the wireless interface to selectively transmit the D2DSS over the wireless interface to at least one further user equipment if the user equipment is enabled to transmit the D2DSS.

The user equipment may be configured to perform the method of any embodiment or aspect disclosed herein.

The processing device may be configured to evaluate whether criteria stored at the user equipment are fulfilled. The processing device may be configured to control the wireless interface to transmit the D2DSS depending on a result of an evaluation of the criteria.

The processing device may be configured to control the wireless interface to stop transmitting the D2DSS when the criteria are no longer fulfilled.

The processing device may be configured to receive signaling which configures the criteria at the wireless interface.

The processing device may be configured to receive the criteria from a base station of the mobile communication network or from a group head of a device-to-device communication group. The user equipment may be configured to receive the criteria in a Radio Resource Control (RRC) signaling or a beacon transmitted by the base station or the group head. The signaling which configures the criteria may be layer 1 or layer 2 signaling.

The user equipment may be configured to transmit a request to a base station of the mobile communication network or to a group head of a device-to-device communication group if the criteria are fulfilled.

The user equipment may be configured to transmit a request to a base station of the mobile communication network or to a group head of a device-to-device communication group, even if no criteria for transmitting the D2DSS are set at the user equipment.

The user equipment may be configured to receive a message from the base station or the group head, which authorizes the user equipment to transmit the D2DSS in response to transmitting the request. The processing device may be configured to control the wireless interface to transmit the D2DSS in response to receiving the message.

The processing device may be configured to retrieve at least one parameter included in the message. The parameter may define any one, or any combination of, a validity duration, a power setting for transmitting the D2DSS, and/or a validity area.

The processing device may be configured to control the wireless interface to transmit the D2DSS as a function of the at least one parameter. The processing device may be configured to control the wireless interface to transmit the D2DSS depending on whether the validity time has already expired and/or whether the user equipment is located within the validity area.

The request may include information on a cause of the request. The cause may indicate whether the request is triggered by a public safety use case, such as an emergency communication. The request may include information on a power capability or on power preferences of the user equipment. The request may include information on a location of the user equipment.

The processing device may be configured to fall back on the evaluation of the criteria as a fallback procedure if, after transmission of the request, the user equipment does not receive a message from the base station or the group head.

The processing device may be configured to control the wireless interface to transmit the D2DSS with a timing which is referenced to a synchronization source.

The processing device may be configured to perform a synchronization source reselection.

The processing device may be configured to identify a further synchronization source which is preferred over the synchronization source based on at least one reselection criterion. The at least one reselection criterion may depend on at least one of a priority of the synchronization source and a priority of the further synchronization source. The at least one reselection criterion may depend on at least one of a signal quality of the synchronization source and a signal quality of the further synchronization source. The processing device may be configured such that a further synchronization source which is a base station may be preferred over a synchronization source which is not a base station. The processing device may be configured such that a further synchronization source which is an other user equipment located within a coverage area of the mobile communication network may be preferred over a synchronization source which is not located within the coverage area of the mobile communication network.

The processing device may be configured to perform a synchronization source reselection when a predefined time interval expires.

The processing device may be configured to receive a reselection message from a base station of the mobile communication network or from a group head of a device-to-device communication group and to perform the synchronization source reselection in response to receiving the reselection message.

The processing device may be configured to control the wireless interface to transmit a reselection request to the base station or to the group head. The processing device may be configured such that the reselection request may include information on the synchronization source, which has previously been used as reference for transmitting the D2DSS, and/or information on the further synchronization source which shall be used as reference for transmitting the D2DSS in the future.

According to another embodiment, a synchronization control unit for controlling a transmission of a D2DSS by a user equipment is provided. The synchronization control unit comprises a wireless interface configured to communicate with the user equipment. The synchronization control unit comprises a control device coupled to the wireless interface and configured to control the wireless interface to enable the user equipment to transmit the D2DSS.

By using a synchronization control unit which can selectively enable transmission of the D2DSS by the user equipment, traffic on the air interface may be reduced and central control over the transmission of the D2DSS may be provided.

The control device may be configured to control the wireless interface to set criteria in the user equipment. The criteria may define under which conditions the user equipment is enabled to transmit the D2DSS.

The control device may be configured to control the wireless interface to transmit a message to the user equipment which enables the user equipment to transmit the D2DSS.

The control device may be configured to control the wireless interface to transmit the message in response to receiving a request from the user equipment. The control device may be configured to control the wireless interface to transmit the message as a function of information included in the request and, optionally, as a function of network parameters.

The control device may be configured to control the wireless interface to transmit a reselection message to the user equipment to cause the user equipment to perform a synchronization source reselection.

The control device may be configured to control the wireless interface to transmit the reselection message in response to receiving a reselection request from the user equipment.

The synchronization control unit may be base station of a mobile communication network. The synchronization control unit may be an evolved NodeB (eNodeB). The base station and the user equipment may be configured to communicate with each other over an evolved UTRA (E-UTRA) air interface.

According to another embodiment, a communication system is provided. The communication system comprises a user equipment according to an embodiment and a synchronization control unit according to an embodiment.

According to another embodiment, a user equipment is provided which comprises a wireless interface configured to communicate with a mobile communication network. The user equipment comprises a processing device coupled to the wireless interface. The processing device is configured to perform a synchronization with a synchronization source. The processing device is configured to perform a synchronization source reselection.

The processing device may be configured to perform the synchronization source reselection by identifying a further synchronization source which is preferred over the synchronization source based on at least one reselection criterion. The at least one reselection criterion may depend on at least one of a priority of the synchronization source and a priority of the further synchronization source. The at least one reselection criterion may depend on at least one of a signal quality of the synchronization source and a signal quality of the further synchronization source.

The processing device may be configured such that a further synchronization source which is a base station may be preferred over a synchronization source which is not a base station. The processing device may be configured such that a further synchronization source which is an other user equipment located within a coverage area of the mobile communication network may be preferred over a synchronization source which is not located within the coverage area of the mobile communication network.

The processing device may be configured to perform the synchronization source reselection after a predetermined time period.

The processing device may be configured to receive a reselection message from a base station of the mobile communication network or from a group head of a device-to-device communication group and to perform the synchronization source reselection in response to receiving the reselection message.

The processing device may be configured to control the wireless interface to transmit a reselection request to the base station or to the group head. The processing device may be configured such that the reselection request may include information on the synchronization source, which has previously been used as a time reference, and/or information on the further synchronization source which shall be used as the time reference in the future.

According to another embodiment, a user equipment is provided which comprises a wireless interface configured to communicate with a mobile communication network. The user equipment comprises a processing device coupled to the wireless interface. The processing device is configured to receive a message from a base station or a group head of a device-to-device communication group at the wireless interface, which enables the user equipment to relay synchronization signals and/or data traffic. The processing device is configured to control the wireless interface, in response to receiving the message, to relay the synchronization signals and/or the data traffic between at least one further user equipment and the base station or the group head of the device-to-device communication group.

A user equipment having such a configuration allows the base station or the group head of the device-to-device communication group to control the relaying of data traffic and/or synchronization signals by the user equipment.

The processing device may be configured to control the wireless interface to transmit a request to the base station or the group head of the device-to-device communication group to request authorization for relaying data traffic and/or synchronization signals.

A communication system according to a further embodiment may comprise the user equipment and a control unit which controls the relaying of synchronization signals and/or data traffic performed by the user equipment by transmitting the message to the user equipment.

In the methods, devices, and systems according to embodiments, a user equipment may be selectively enabled to transmit the D2DSS. The mobile communication network or a group head of a D2D group is provided with the capability of controlling the transmission of the D2DSS.

Although specific features described in the above summary and the following detailed description are described in the context of specific embodiments and aspects of the invention, the features of the embodiments and aspects may be combined with each other unless specifically noted otherwise.

### BRIEF DESCRIPTION OF DRAWINGS

Embodiments of invention will now be described in more detail with reference to the accompanying drawings in which like or identical reference numerals designate like or identical elements.

FIG. 1 shows a communication system according to an embodiment.

FIG. 2 shows the communication system of FIG. 1, which includes a Proximity Service-enabled user equipment.

FIG. 3 is a flow chart of a method according to an embodiment.

FIG. 4 is a diagram which shows a signaling in a communication system according to an embodiment.

FIG. 5 is a flow chart of a method according to an embodiment.

FIG. 6 is a diagram which shows a signaling in a communication system according to an embodiment.

FIG. 7 is a diagram which shows a signaling in a communication system according to an embodiment.

FIG. 8 is a diagram which shows a signaling in a communication system according to an embodiment.

FIG. 9 shows a request which may be transmitted by a user equipment according to an embodiment.

FIG. 10 shows a message which may be received by a user equipment according to an embodiment.

FIG. 11 is a diagram which shows a signaling in a communication system according to an embodiment.

FIG. 12 is a flow chart of a method according to an embodiment.

FIG. 13 is a diagram which shows a signaling in a communication system according to an embodiment.

FIG. 14 is a diagram which shows a signaling in a communication system according to an embodiment.

FIG. 15 is a diagram which shows a signaling in a communication system according to an embodiment.

FIG. 16 is a diagram which shows a signaling in a communication system according to an embodiment.

FIG. 17 shows a reselection request which may be transmitted by a user equipment according to an embodiment.

### DESCRIPTION OF EMBODIMENTS

In the following, exemplary embodiments of the invention will be described in more detail. It has to be understood that the features of the various exemplary embodiments described herein may be combined with each other unless specifically noted otherwise. Identical or similar reference numerals refer to identical or similar components.

While exemplary embodiments will be described with reference to certain use cases for device-to-device (D2D) discovery and communication, it is to be understood that the synchronization techniques may be used for a wide variety of use cases, including public safety use cases and other commercial use cases. While exemplary embodiments will be described in the context of certain cellular mobile communication networks, e.g. Long Term Evolution (LTE) networks, the embodiments are not described to such mobile communication techniques.

While some exemplary embodiments will be described with reference to a base station which configures whether and under which conditions a user equipment is enabled to transmit a synchronization signal (referred to as D2DSS herein) for D2D discovery and/or D2D communication, it is to be understood that a user equipment may be enabled to transmit the D2DSS also by a repeater relay or by an other user equipment which acts as a group head for D2D communication, for example.

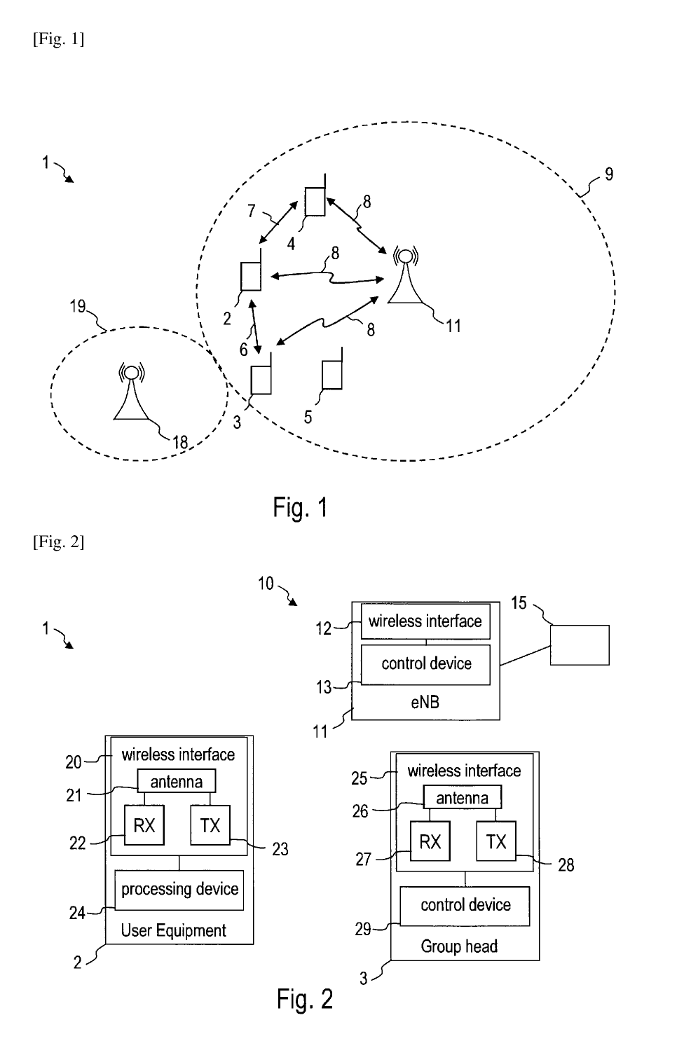

FIG. 1 shows a communication system 1 according to an embodiment. The communication system 1 includes a mobile communication system which is configured as a cellular wireless communication network. The cellular wireless communication network may comprise a plurality of base stations 11, 18. The base stations 11, 18 may communicate with each other via wireless radio communications or via an operator core network. The cellular wireless communication network may be a Long Term Evolution (LTE) network. A radio access network (RAN) of the cellular wireless communication network may be an evolved UTRAN (E-UTRAN), with the base station 11, 18 being an evolved Node B (eNodeB). The base stations 11, 18 may be connected to a Mobility Management Entity (MME) and/or Serving Gateway (S-GW) in the operator core network.

The base station 11 provides a radio cell 9 in which user equipments (UEs) 2, 3, 4, 5 may communicate directly with the base station 11 via radio communication 8. The UEs 2, 3, 4, 5 may respectively have a wireless interface for communication with the E-UTRAN. The base station 18 provides coverage for another radio cell 19.

At least one of the UEs 2, 3, 4, 5 is capable of performing a D2D discovery for D2D communication. According to the terminology in the pertinent field of the art, the term D2D communication refers to a radio communication between UEs which is performed directly between the UEs. The radio signals 6, 7 transmitted in the D2D communication may not be processed by the base stations 11, 18. The radio signals 6, 7 transmitted in the D2D communication may not pass the RAN of the communication network. The radio signals 6, 7 transmitted in the D2D communication may not be processed by a core network of the wireless cellular communication network. The UEs which are configured for D2D communication may use the same wireless interface for communicating with the RAN and for D2D communication. A UE configured for D2D discovery and D2D communication may also be referred to as Proximity Service (ProSe)-enabled UE in the art.

In order to identify suitable communication partners for D2D communication, a UE capable of performing D2D communication may be configured to perform a D2D discovery. In the D2D discovery, a UE may discover at least one further UE located in proximity of the UE and configured to engage in D2D communication with the UE. The D2D discovery may include a radio signaling between UEs which is performed directly between the UEs. The radio signals transmitted in the D2D discovery may not be processed by the base station 11. The radio signals transmitted in the D2D discovery may not pass through the RAN of the communication network. The radio signals transmitted in the D2D discovery may not be processed by a core network of the wireless cellular communication network. The UEs which are configured for D2D communication may use the same wireless interface for communicating with the RAN and for D2D discovery.

A UE 2 according to an embodiment which is configured for D2D communication may transmit a D2DSS. The UE 2 may transmit the D2DSS with a timing which is referenced to a synchronization source. To this end, the UE 2 may relay a D2DSS which it receives from the synchronization source. I.e., the UE 2 may re-transmit a received D2DSS in response to receiving the D2DSS. If no synchronization source is available the UE 2 may nevertheless transmit a D2DSS.

In any one of the various embodiments, the D2DSS transmitted by a synchronization source and the D2DSS transmitted by the UE 2 may include or may be a Zadoff Chu sequence. In any one of the various embodiments, the D2DSS transmitted by a synchronization source and the D2DSS transmitted by the UE 2 may include or may be a M sequence.

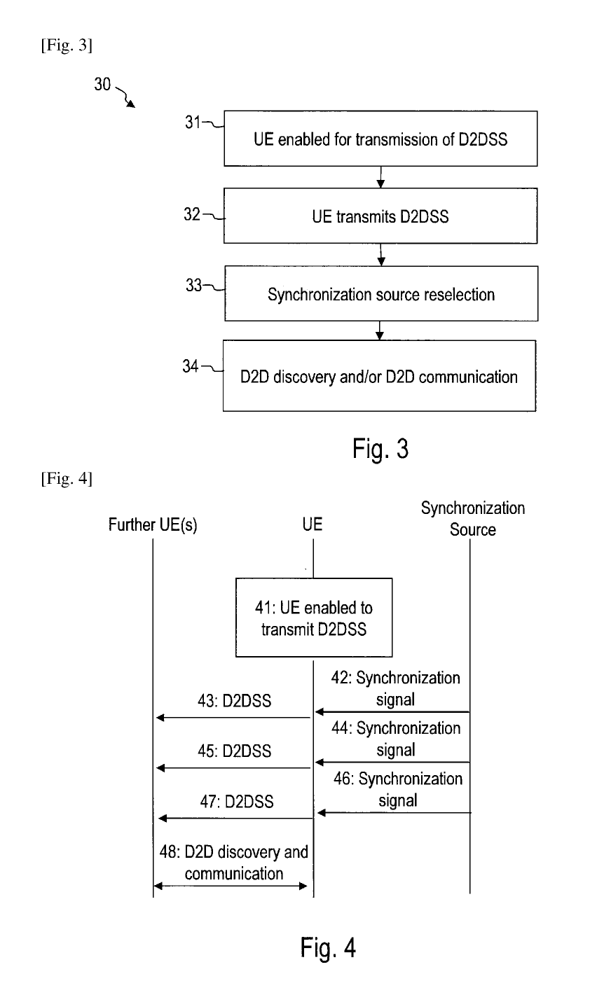

As will be explained in more detail with reference to FIG. 3 to FIG. 11, the UE 2 may be configured such that the UE 2 can be selectively enabled to transmit the D2DSS. This may happen under the control of a base station 11, 18, or under the control of an other UE 3 which acts as a group head of a D2D communication group. The UE 2 can be enabled for transmission of the D2DSS in such a manner that the UE 2 evaluates criteria which are stored temporarily, persistently or semi-persistently at the UE 2. Depending on whether the criteria are fulfilled, the UE 2 may transmit the D2DSS, e.g. by relaying a D2DSS received from a synchronization source. Alternatively or additionally, the UE 2 can be enabled for transmission of the D2DSS in such a manner that the UE 2 transmits a request to the base station 11, 18 or to the other UE 3 which acts as group head to request that it can be enabled for the transmission of the D2DSS. When the UE 2 receives a message which approves the transmission of the D2DSS by the UE 2, the UE 2 can start transmitting the D2DSS. When no base station and no other UE 3 acting as group head is available, the UE 2 may fall back onto evaluating whether the criteria are fulfilled in a fallback routine.

As will be explained in more detail with reference to FIG. 12 to FIG. 17, the UE 2 may alternatively or additionally be configured such that the UE 2 can perform a synchronization source reselection. This may be implemented in various ways. For illustration, the UE 2 can identify a further synchronization source which has a higher priority or which provides a better signal quality than the synchronization source to which the UE 2 is presently referenced. The UE 2 may additionally or alternatively perform a signaling to obtain authorization for a synchronization source reselection. The UE 2 may transmit a reselection request to the base station 11, 18 or to the other UE 3 which acts as the group head to request permission for a synchronization source reselection. When the UE 2 receives a reselection message which approves the synchronization source reselection, the UE 2 can start using the further synchronization source as a time reference.

FIG. 2 is a schematic block diagram of a communication system 1 according to an embodiment. The base station 11 of the RAN 10 is connected to a node 15 of the RAN or the core network (CN). For illustration, for a base station 11 implemented as an eNodeB, the node 15 may be an MME or S-GW.

The UE 2 has a wireless interface 20. The wireless interface 20 may be configured to communicate with the RAN 10. The wireless interface 20 may be configured for communication over the E-UTRA air interface.

The UE 2 has a processing device 24 connected to the wireless interface 20. The processing device 24 may comprise one or several microprocessors, one or several microcontrollers, one or several processors, one or several controllers, one or several application specific integrated circuits (ASICs) and/or a combination of such devices.

The processing device 24 may be configured to determine whether a D2DSS is to be transmitted. The processing device 24 may evaluate criteria and/or may perform a signaling with a base station or an other UE to determine whether the UE 2 is enabled to transmit the D2DSS. When the UE 2 is enabled to transmit the D2DSS, the processing device 24 may monitor a receiver path 22 coupled to an antenna 21 to detect receipt of a D2DSS. The processing device may control a transmitter path 23 to cause the D2DSS to be transmitted again, thereby effectively relaying the D2DSS. The D2DSS transmitted by the UE 2 may be identical to the received D2DSS. The UE 2 may also modify the D2DSS, i.e., the D2DSS transmitted by the UE 2 may be derived from the D2DSS received by the UE 2 from a synchronization source.

The processing device 24 may be configured to cause a transmission of the D2DSS via the wireless interface 20 with a timing which may be referenced to a synchronization source. The processing device 24 may be configured to perform a synchronization source reselection, which causes the reference for the transmission of the D2DSS to be changed from the synchronization source to a further synchronization source. The processing device 24 may be configured to evaluate a priority of the synchronization source and of the further synchronization source to determine whether the synchronization source reselection is to be performed. The processing device 24 may be configured to monitor signal characteristics of signals received from the synchronization source and of the further synchronization source to determine whether the synchronization source reselection is to be performed. The processing device 24 may be configured to control the transmitter path 23 to cause a transmission of a request to a base station 11 or the other UE 3 which acts as group head, in order to obtain permission for the synchronization source reselection. The processing device 24 may be configured to monitor the receiver path 22 to detect a receipt of a reselection message from the base station 11 or the group head.

The base station 11 includes a wireless interface 12. The wireless interface 12 may be configured to communicate with the UE 2. The wireless interface 12 may be configured for communication over the E-UTRA air interface.

A control device 13 of the base station 11 may control the wireless interface 12 to enable the UE 2 to transmit the D2DSS. To this end, the control device 13 may control the wireless interface 12 to transmit signaling to configure criteria in the UE 2 which will be evaluated by the UE 2 to determine whether the UE 2 is enabled to transmit the D2DSS. The control device 13 may additionally or alternatively control the wireless interface 12 to transmit a message to the UE 2 which enables the UE 2 to transmit the D2DSS, in response to receiving a request from the UE 2.

Alternatively or additionally, the control device 13 may control the wireless interface 12 to cause the UE 2 to perform a synchronization source reselection.

The other UE 3 acts as a group head of a D2D communication group. The other UE has a wireless interface 25 which includes an antenna 26, a receiver path 27, and a transmitter path 28. The UE has a control device 29 connected to the wireless interface 25. The control device 29 may comprise one or several microprocessors, one or several microcontrollers, one or several processors, one or several controllers, one or several application specific integrated circuits (ASICs) and/or a combination of such devices.

The control device 29 may control the wireless interface 25 to enable the UE 2 to transmit the D2DSS. To this end, the control device 29 may control the wireless interface 25 to transmit signaling which sets criteria in the UE 2 which will be evaluated by the UE 2 to determine whether the UE 2 is enabled to transmit the D2DSS. The control device 29 may additionally or alternatively control the wireless interface 25 to transmit a message to the UE 2 which enables the UE 2 to transmit the D2DSS, in response to receiving a request from the UE 2.

Alternatively or additionally, the control device 29 may control the wireless interface 25 to cause the UE 2 to perform a synchronization source reselection.

FIG. 3 is a flow chart of a method 30 according to an embodiment. The method may be performed by a UE according to an embodiment.

At 31, the UE is enabled for transmission of the D2DSS. This may comprise evaluating criteria at the UE. For illustration the criteria may indicate that the UE is enabled to transmit the D2DSS if the UE needs D2D, but does not receive a D2DSS at its wireless interface. Alternatively or additionally, the UE may transmit a request to request authorization for transmission of the D2DSS. The UE may transmit the D2DSS when receiving a message which permits the UE to transmit the D2DSS, thereby enabling the UE for the transmission of the D2DSS.

At 32, the UE may transmit the D2DSS. The transmission of the D2DSS may be performed with a timing which is referenced to a synchronization source. The transmission of the D2DSS may include relaying a D2DSS received by the UE or otherwise transmitting the D2DSS which is derived from a D2DSS received from a synchronization source.

At 33, the UE may optionally perform a synchronization source reselection. The UE may determine whether a further synchronization source is available which is preferred over the synchronization source used at 32. The UE may be caused to perform the synchronization source reselection by receipt of a reselection message from a base station or a group head of a D2D communication group. The UE may be caused to perform the synchronization source reselection by expiry of a timer.

At 34, the UE perform a D2D discovery and/or D2D communication.

FIG. 4 is a diagram which illustrates signaling in a communication system according to an embodiment.

A UE is enabled to transmit the D2DSS at 41. The UE may scan for a synchronization source. The UE may transmit the D2DSS 43, 45, 47 by receiving the D2DSS or another synchronization signal 42, 44, 46 from the synchronization source. The UE may transmit the D2DSS 43, 45, 47 with a timing which is referenced against the synchronization source. The UE may generate the D2DSS 43, 45, 47 such that the D2DSS 43, 45, 47 is derived from the synchronization signal 42, 44, 46 received from the synchronization source. The D2DSS 43, 45, 47 may include a Zadoff Chu sequence or an M sequence.

The UE may transmit the D2DSS 43, 45, 47 to at least one further UE. The UE may transmit the D2DSS 43, 45, 47 as a broadcast or multicast message.

When more than one synchronization source is available, the UE may perform a prioritization among several available synchronization sources. The UE may be configured to perform the prioritization such that synchronization sources which are eNodeBs have a higher priority than synchronization sources which are other UEs. The UE may be configured to perform the prioritization such that synchronization sources which are UEs within network coverage have a higher priority than synchronization sources which are UEs outside network coverage

If no synchronization source is detected, a UE may nevertheless transmit he D2DSS.

The UE may be configured to reselect the D2D Synchronization Source it uses as the time reference, as will be explained in more detail with reference to FIG. 12 to FIG. 17.

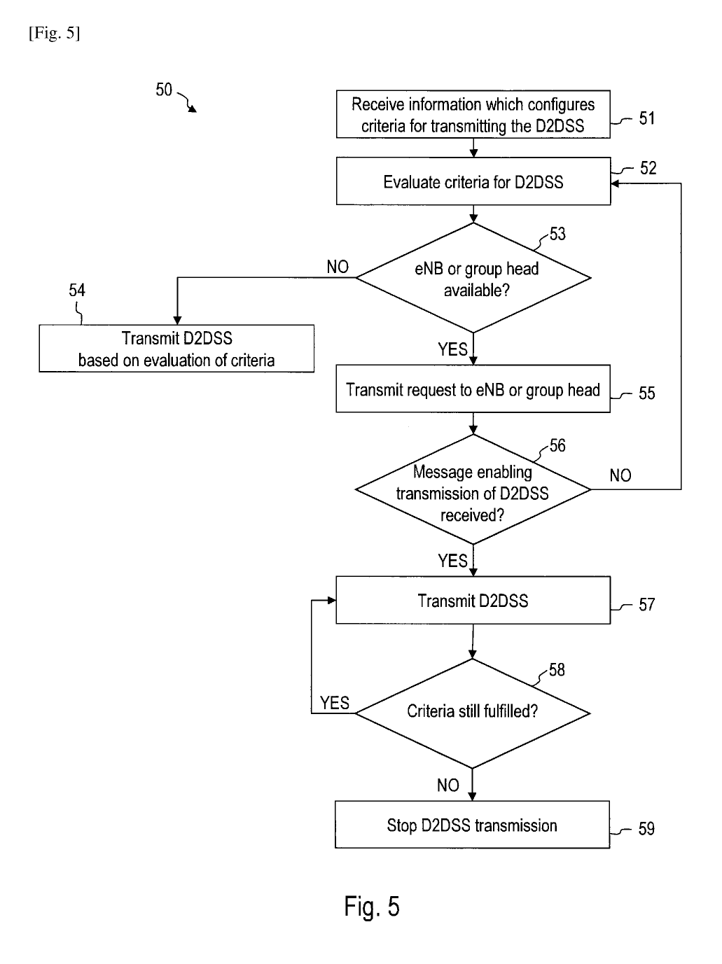

FIG. 5 is a flow chart of a method 50 according to an embodiment. The method 50 may be performed by a UE according to an embodiment. The method 50 may be used by the UE to determine whether it is enabled to transmit the D2DSS.

At 51, the UE may receive criteria for transmitting the D2DSS. The criteria may be configured in the UE by signaling received from a base station or from a group head of a D2D communication group. Alternatively, the criteria may be a predefined rule which may depend on whether a D2DSS is received at the wireless interface of the UE, for example, or which may depend on a signal quality of a D2DSS received at the wireless interface of the UE.

At 52, the UE may evaluate whether the criteria are fulfilled. The criteria may have one or several input parameters which may be evaluated by the UE to determine whether the criteria are fulfilled. For illustration, the criteria may define that the UE is enabled to transmit the D2DSS if it requires D2D communication and if the UE does not receive a D2DSS from another UE. The criteria may further define that the UE is enabled to transmit the D2DSS if the UE does not require D2D communication, while a signal quality of a D2DSS received at the wireless interface and/or a speed at which the UE moves and/or mobile network communication procedures in which the UE is engaged fulfill certain criteria.

At 53, when the criteria are fulfilled, the UE may determine with an eNodeB or a group head of a D2D communication group is available for requesting authorization for transmitting the D2DSS. When the UE determines that the eNodeB or the group head is available, the UE may transmit the D2DSS as long as the criteria are fulfilled at 54. Otherwise, the method proceeds to step 55.

At 55, the UE transmits a request to the eNodeB or the group head of the D2D communication group to request authorization for transmitting the D2DSS. As will be explained in more detail with reference to FIG. 7 to FIG. 9, the request may include information which allows the eNodeB or the group head to determine whether the UE shall be enabled to transmit the D2DSS.

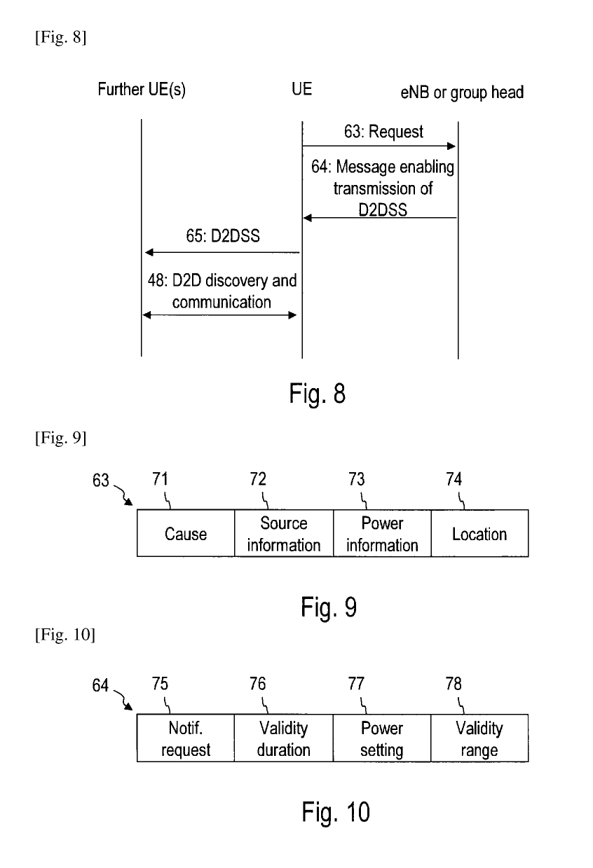

At 56, the UE determines whether it receives a message which enables transmission of the D2DSS from the eNodeB or the group head. As will be explained in more detail with reference to FIG. 7, FIG. 8, and FIG. 10, the message may include information which defines a validity time and/or a validity area in which the UE may transmit the D2DSS. The message may include additional information which defines a transmit power or other parameters of the transmission of the D2DSS. If the message enabling the UE to transmit the D2DSS is not received, the method may return to step 52. Otherwise, the method may proceed to step 57.

At 57, the UE transmits the D2DSS. The UE may transmit the D2DSS with a timing which is referenced to a synchronization source.

At 58, the UE may determine whether the criteria for transmission of the D2DSS are still fulfilled. If the criteria are still fulfilled, the method may continue transmitting the D2DSS at 57. Otherwise, the UE may stop transmitting the D2DSS at 59.

As explained with reference to FIG. 5, the UE may use the evaluation of criteria as a fallback procedure when no eNodeB or group head is available for requesting authorization to transmit the D2DSS.

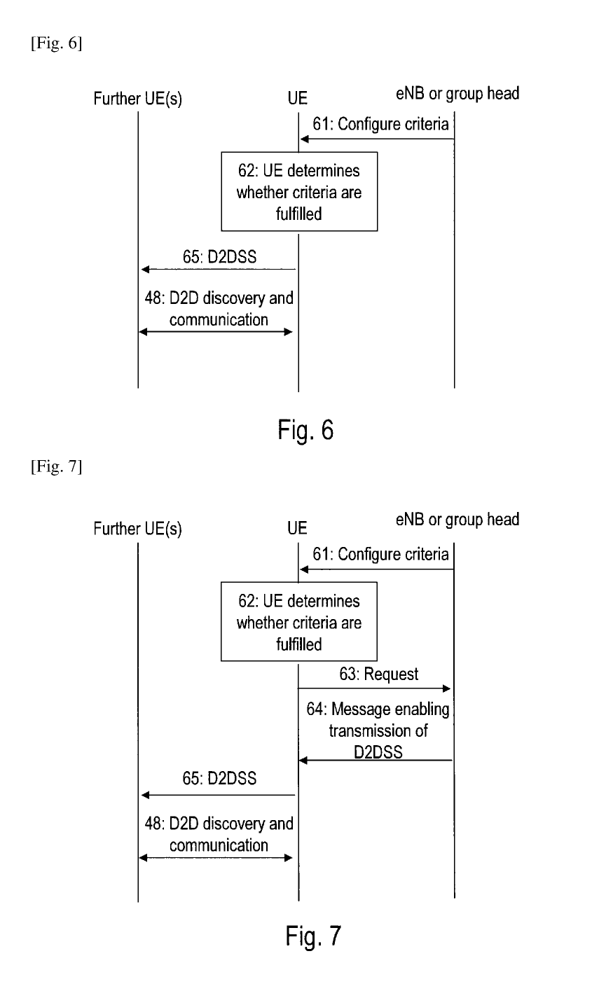

With reference to FIG. 6 to FIG. 11, techniques which may be used for controlling the transmission of the D2DSS by the UE according to an embodiment will be described in more detail.

FIG. 6 is a diagram which shows signaling in a communication system according to an embodiment. A UE may receive a signaling which sets criteria which define when the UE can be enabled to transmit the D2DSS. An eNodeB or group head may transmit an RRC message 61 or a beacon 61 to configure the criteria in the UE. The UE will determine whether the criteria are fulfilled, i.e. will evaluate the criteria, to determine whether the UE may transmit the D2DSS.

The UE performs an evaluation of the criteria 62. The UE may use one or several input parameters available locally at the UE to evaluate the criteria. The criteria may have any one of a variety of forms. For illustration, the criteria may define that, when the UE requires D2D communication, it may transmit the D2DSS if it does not receive a D2DSS from another UE. Alternatively or additionally, the criteria may define that, when the UE does not require D2D communication, it may transmit the D2DSS if a signal quality indicator of a D2DSS received at the wireless interface of the UE fulfill predefined quality criteria. Alternatively or additionally, the criteria may define that, when the UE does not require D2D communication, it may transmit the D2DSS if a speed of the UE fulfills predefined speed criteria. Alternatively or additionally, the criteria may define that, when the UE does not require D2D communication, it may transmit the D2DSS if it is not engaged in cell selection or handover procedures. The various criteria for signal quality indicators and/or UE speed may be fixed or may be configured by the eNodeB or the group head.

The UE transmits the D2DSS 65 when the evaluation of the criteria shows that the criteria are fulfilled. The UE may perform D2D discovery and/or D2D communication 48, using the D2DSS 65.

FIG. 7 is a diagram which shows signaling in a communication system according to an embodiment. The evaluation of criteria may be combined with signaling to request authorization to transmit the D2DSS. A UE may receive signaling 61 which configures the criteria in the UE, as explained with reference to FIG. 6.

The UE transmits a request 63 to the eNodeB or the group head when the evaluation of the criteria shows that the criteria are fulfilled, i.e., that the criteria configured by the eNodeB or group head are met. When the UE has in the meantime moved into another cell or into another D2D communication group, the request 63 does not need to be transmitted to the eNodeB or group head which configured the criteria in the UE at 61.

The eNodeB or group head which receives the request 63 acts as a central synchronization control unit for controlling the transmission of the D2D. The eNodeB or group head which receives the request may evaluate the request in combination with network parameters to determine whether the UE will be enabled to transmit the D2DSS. The eNodeB may permit the UE to transmit the D2DSS only if the data traffic and/or signaling on the air interface of the mobile communication network are low.

The eNodeB or the group head may always permit the UE to transmit the D2DSS if the request 63 indicates that the UE requires D2D communication for a public safety use case, e.g. emergency voice or data communication.

The eNodeB or the group head may transmit a message 64 which enables the UE to transmit the D2DSS. The message 64 may define a validity, in the temporal and/or spatial domain, for the permission to transmit the D2DSS. The message 64 may define parameters which are to be used by the UE for transmitting the D2DSS. The message 64 enabling the UE to transmit the D2DSS may be received by the UE only if the eNodeB or the group head determines that the UE may transmit the D2DSS.

FIG. 8 is a diagram which shows signaling in a communication system according to an embodiment. In the signaling of FIG. 8, the UE does not need to evaluate criteria to determine whether it is enabled to transmit the D2DSS, but may instead transmit the request 63 to the eNodeB or group head. When the UE receives the message 64 which enables the UE to transmit the D2DSS, the UE may transmit the D2DSS 65.

In yet another implementation, the eNodeB or group head may transmit the message 64 also when it does not receive the request 63. This allows a network initiated control over the D2DSS transmission to be realized. The base station or the group head may transmit the message 64 which authorizes the user equipment to transmit the D2DSS when a further user equipment different from the user equipment requests the base station or group head to initiate transmission of the D2DSS by the user equipment, for example.

If the signaling explained with reference to FIG. 8 fails, e.g. because the UE is out of coverage of the mobile communication network, the UE may fall back onto evaluating the criteria to determine whether it is enabled to transmit the D2DSS, as explained with reference to FIG. 6.

The signaling which includes the transmission of the request 63 to the eNodeB or to the group head, and/or the receipt of the message 64 by the UE may not only be used for authorizing the UE to relay the D2DSS, but may also be used by the UE for obtaining authorization for relaying data traffic. In this case, instead of or additionally to relaying the D2DSS, the UE may relay data traffic between the at least one further UE and the base station or the group head in response to receiving the message 64.

FIG. 9 illustrates a request 63 which may be transmitted from the UE to the eNodeB or the group head to obtain authorization for transmit the D2DSS. The request 63 may be transmitted in the signaling of FIG. 7 or in the signaling of FIG. 8.

The request 63 may include a cause 71 which indicates why the UE requests authorization to transmit the D2DSS. The cause 71 may indicate transmission needs of the UE. The cause 71 may indicate that the UE is located at a cell boundary. The cause 71 may indicate that the UE intends to perform public safety related communication. The cause 71 may indicate that the UE has detected a new D2DSS from a neighbor cell of the cellular communication network or from another D2D communication group. The cause 71 may indicate a relay capability of the UE. The cause 71 may indicate whether the UE is willing to act as a repeater relay for at least one further UE.

Additionally or alternatively, the request 63 may include a source information 72 on a synchronization source. The source information 73 may indicate changes or hops of the synchronization source. The source information 73 may additionally or alternatively indicate a type of the synchronization source. The type of the source may define whether the synchronization source is a network node, e.g. an eNodeB, a group head of a D2D communication group, a UE located out-of-coverage of the mobile communication network, or a UE located in coverage of the mobile communication network. The type of the source may define a priority class of the synchronization source. For illustration, a network node may have a higher priority class than a synchronization source which is an other UE. Among other UEs, a UE located in coverage of the mobile communication network may have a higher priority class than a UE located out-of-coverage of the mobile communication network. The source information 73 may additionally or alternatively indicate a signal-to-noise ratio, a signal strength or another signal quality indicator for synchronization signals received from the synchronization source at the UE.

Additionally or alternatively, the request 63 may include information 73 on a power capability or power preferences of the UE. The information 73 on the power capability may indicate a power range and/or a power saving option set at the UE. The information 73 on the power capability may depend on a battery level of the UE. The information 73 on the power capability may depend on user activated settings, e.g. in-flight-mode.

Additionally or alternatively, the request 63 may include information 74 on a location of the UE.

FIG. 10 illustrates a message 64 which may be transmitted to the UE by the eNodeB or the group head to grant authorization for transmit the D2DSS. The message 64 may be transmitted in the signaling of FIG. 7 or in the signaling of FIG. 8.

The message 64 may include a validity duration 76 which defines a validity time period for which the UE is enabled to transmit the D2DSS. The UE may monitor the expiry of the validity time period and may stop transmission of the D2DSS when the validity time period expired. The UE may start a timer when the message 64 is received and may monitor expiry of the timer to detect that the validity time period has lapsed.

The message 64 may include a validity range 78 which defines a spatial validity area in which the UE is enabled to transmit the D2DSS. The UE may monitor the whether it is located within the validity area and may stop transmission of the D2DSS when it is located outside of the validity area.

The message 64 may include a power setting 77 which shall be used by the UE for transmitting the D2DSS. The power setting 77 may define a transmit power for transmission of the D2DSS. The power setting 77 may define a power range for transmission of the D2DSS.

The message 64 may include a notification request 75. When the notification request 75 is included in the message 64, this will trigger the UE to report to the eNodeB or group head when it stops transmitting the D2DSS. Alternatively, the notification request 75 may cause the UE to report to the eNodeB or group head when it stops data traffic relaying. The notification request 75 may request the UE to transmit a report which indicates a cause for stopping the transmission of the D2DSS. Exemplary causes include cell selection, handover, low power, out of location range, out of coverage, or similar.

While the UE may request authorization to transmit the D2DSS, and the eNodeB or group head may grant such an authorization, the request 63 and the message 64 do not need to be transmitted. For illustration, if no connection to an eNodeB or group head can be established, the UE may evaluate criteria as shown in FIG. 6 to determine whether it may transmit the D2DSS.

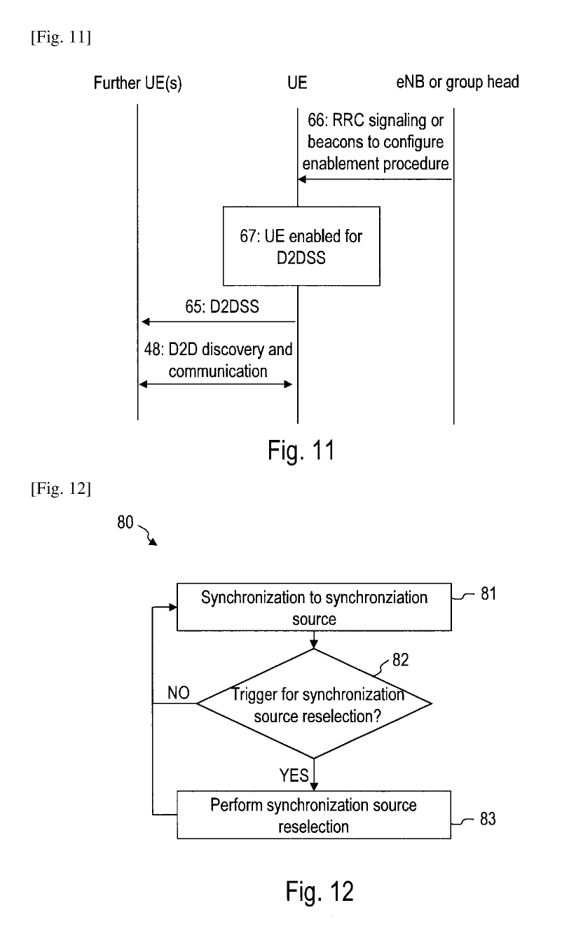

The UE may use any one of a variety of procedures to determine whether it is enabled to transmit the D2DSS. The procedures include evaluation of criteria as explained with reference to FIG. 6, evaluation of criteria in combination with requesting authorization as explained with reference to FIG. 7, or requesting authorization without evaluating the criteria as explained with reference to FIG. 8. The mobile communication network or a group head of a D2D communication group may configure which one of the procedures the UE shall use, as illustrated in FIG. 11.

FIG. 11 is a diagram which shows signaling in a communication system according to an embodiment. In the signaling of FIG. 11, the UE receives a RRC signaling or beacon(s) 66 transmitted by the eNodeB or the group head, which define how the UE shall determine whether it is enabled for transmitting the D2DSS. The RRC signaling or beacon(s) 66 may define whether the UE shall perform an evaluation of criteria as explained with reference to FIG. 6, evaluation of criteria in combination with requesting authorization as explained with reference to FIG. 7, or requesting authorization without evaluating the criteria as explained with reference to FIG. 8 to determine whether it is enabled for transmitting the D2DSS. Alternatively, the RRC signaling or beacon(s) 66 may define a priority among the various procedures. The RRC signaling or beacon(s) 66 may be implemented as layer 1 or layer 2 signaling.

At 67, the UE may then determine in accordance with the procedure(s) defined by the received RRC signaling or beacon(s) 66 whether it is enabled for transmitting the D2DSS.

A UE which operates using a synchronization source as a timing reference may perform a synchronization source reselection, as explained in more detail with reference to FIG. 12 to FIG. 17.

FIG. 12 is a flow chart of a method 80 according to an embodiment. The method 80 may be performed by a UE according to an embodiment.

At 81, the UE may use a synchronization source as a timing reference. For illustration, the UE may transmit the D2DSS by relaying a D2DSS received from a synchronization source, for example.

At 82, the UE determines whether a trigger event for synchronization source reselection is fulfilled. If the UE determines that the trigger event is not fulfilled, the UE continues transmitting the D2DSS at 81. If the UE determines that the trigger event is fulfilled, the method proceeds to step 83.

At 83, the UE may perform a synchronization source reselection. The synchronization source reselection may cause the UE to use a new synchronization source as time reference. This may include aligning a receiver of the UE and/or a transmission timing of the D2DSS by the UE with the new synchronization source. The reselection at 83 may include synchronizing a receiver of the UE to the synchronization source. The method may then return to step 81, where the UE transmits the D2DSS with a timing which is referenced to the new synchronization source.

With reference to FIG. 1, the different synchronization sources may be implemented by different base stations 11, 18 or by different group heads 3.

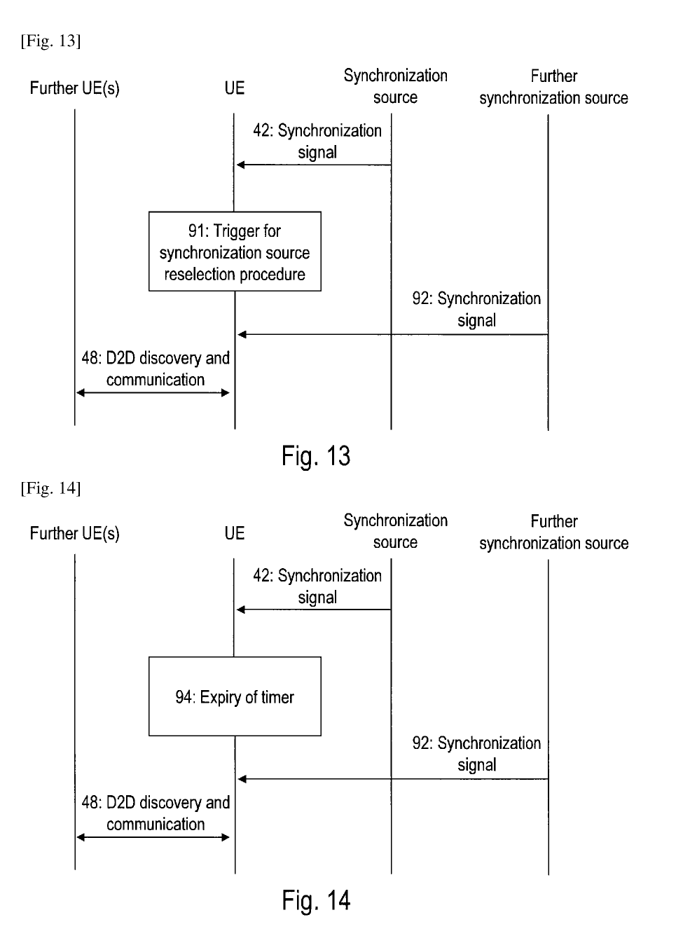

FIG. 13 is a diagram which shows signaling in a communication system according to an embodiment. In the signaling of FIG. 13, the UE may transmit the D2DSS 43 in a manner which uses a synchronization source as a time reference. For illustration, the UE may have a receiver which is synchronized to the synchronization source. The UE may attain time synchronization by relaying a D2DSS or other synchronization signal 42 as the D2DSS 43.

At 91, the UE detects a trigger for a synchronization source reselection procedure. This causes the UE to start using a further synchronization source different from the original synchronization source as a time reference for transmitting the D2DSS. The UE may transmit the D2DSS in a manner which uses the further synchronization source as a time reference. For illustration, the UE may have a receiver which is synchronized to the further synchronization source in a synchronization source reselection procedure performed in response to the trigger 91. The UE may attain time synchronization by relaying a D2DSS or other synchronization signal 92 received from the further synchronization source as the D2DSS.

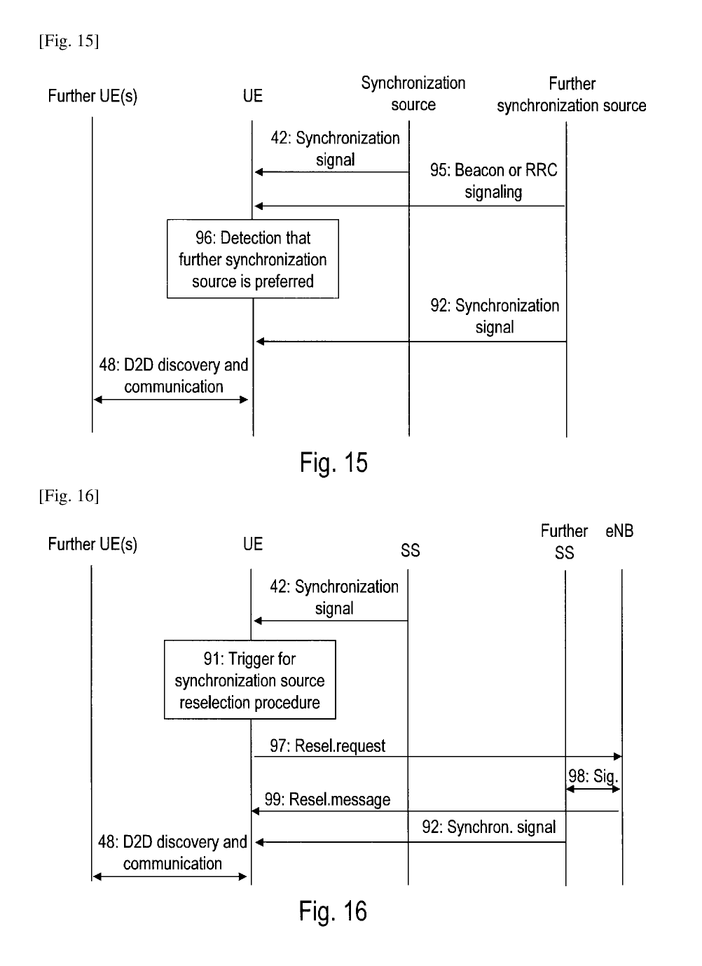

The synchronization source reselection may be triggered in any one of a variety of ways or combinations thereof. For illustration, after a synchronization source has been selected, lapse of a time interval may cause the UE to perform the synchronization source reselection, as will be explained with reference to FIG. 13. Lapse of the time interval may be monitored locally at the UE. The UE may perform the synchronization source reselection when it identifies a further synchronization source which is preferred over the presently used synchronization source, as will be explained with reference to FIG. 14. The UE may obtain authorization from an eNodeB or a group head for performing the synchronization source reselection, as will be explained in detail with reference to FIG. 15 and FIG. 16.

FIG. 14 is a diagram which shows signaling in a communication system according to an embodiment. In the signaling of FIG. 14, the UE may start a timer when selecting the synchronization source as time reference for the transmission of the D2DSS 43. The UE may detect an expiry of the timer 94. This may trigger the UE to perform a synchronization source reselection in which a further synchronization source is identified as best synchronization source. A source reselection criterion may be used to identify the best synchronization source, as will be explained in more detail with reference to FIG. 15. The UE starts using the further synchronization source as a time reference, as explained with reference to FIG. 13. The timer may be reset and started again when the UE starts using the further synchronization source as the time reference.

FIG. 15 is a diagram which shows signaling in a communication system according to an embodiment. In the signaling of FIG. 15, the UE may receive a beacon or RRC signaling or a further synchronization signal 95 from the further synchronization source while the UE still uses the synchronization source as time reference for transmitting the D2DSS. Based on the signal 95, the UE detects at 96 that the further synchronization source may be preferred as a time reference over the synchronization source which is presently being used.

The detection 96 may be implemented in a wide variety of ways and may use a wide variety of parameters. The UE may compare priorities of the synchronization source and the further synchronization source. A network node may have a higher priority than a synchronization source which is an other UE. Among other UEs, a UE located in coverage of the mobile communication network may have a higher priority than a UE located out-of-coverage of the mobile communication network.

Alternatively or additionally, the UE may evaluate a SNR, a signal strength or another signal quality indicator of synchronization signals 42, 95 received from the synchronization source and the further synchronization source. Good signal quality may be preferred over poorer signal quality.

Other criteria may be used, such as a relative movement between the UE and the signal source or a relative movement between the UE and the further signal source. A UE located on a vehicle may prefer a further synchronization source located on the same vehicle as a time reference, for example.

In response to the detection 96 that the further synchronization source is preferred as a time reference, the UE may start using the further synchronization source as time reference, as explained with reference to FIG. 13.

In order to avoid too frequent changes of the time reference, the UE may perform the detection 96 only when a predetermined time interval has lapsed since the UE has started using the synchronization source as the time reference.

Both in the procedure of FIG. 14 and in the procedure of FIG. 15, the UE may request authorization for synchronization source reselection from an eNodeB or a group head of a D2D communication group, as will be explained with reference to FIG. 16.

FIG. 16 is a diagram which shows signaling in a communication system according to an embodiment. In the signaling of FIG. 16, the UE may detect a trigger 91 for a synchronization source reselection procedure.

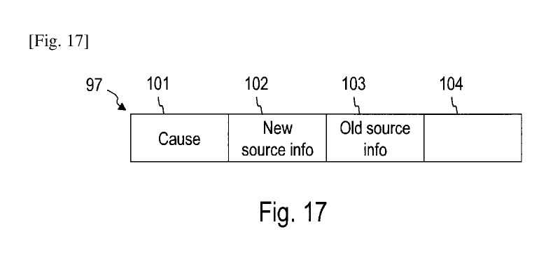

The UE may transmit a reselection request 97 to the eNodeB or the group head of a D2D communication group. The reselection request 97 may include various information which allows the eNodeB or the group head to determine whether the UE may start using the further synchronization source as a new time reference, as will be explained in more detail with reference to FIG. 17. The eNodeB or the group head evaluates the reselection request 97 to determine whether the UE may start using the further synchronization source as the new time reference.

When the eNodeB or the group head determines that the UE may start using the further synchronization source as the new time reference, the UE may receive a reselection message 99 which authorizes the UE to start using the further synchronization source as the new time reference. Only in response to receiving the reselection message 99 the UE starts using the further synchronization source as time reference for transmitting the D2DSS.

When the eNodeB or the group head determines that the UE may start using the further synchronization source as the new time reference, it may optionally perform a signaling 98 with the further synchronization source. The signaling 98 may cause the further synchronization source to provide synchronization signals for the UE. The signaling 98 may also be omitted. In particular, the UE may transmit the reselection request 97 to the eNodeB or the group head to indicate that a better source is available.

FIG. 17 illustrates a reselection request 97 which may be transmitted from the UE to the eNodeB or the group head to obtain authorization for selecting the further synchronization source as a new time reference. The reselection request 97 may be transmitted in the signaling of FIG. 16.

The reselection request 97 may include information 102 on the further synchronization source which the UE intends to start using as the new time reference. The information 102 may indicate a priority, a signal quality indicator, or other information relating to the further synchronization source.

The reselection request 97 may include information 103 on the synchronization source which the UE presently uses as the time reference. The information 103 may indicate a priority, a signal quality indicator, or other information relating to the synchronization source.

The reselection request 97 may include a cause 101 for transmission of the reselection request 97. The cause 101 may indicate transmission needs of the UE. The cause 101 may indicate that the UE is located at a cell boundary. The cause 101 may indicate that the UE intends to perform public safety related communication. The cause 101 may indicate that the UE has detected a new D2DSS from neighbor cell of the cellular communication network or from another D2D communication group. The cause 101 may indicate a relay capability of the UE. The cause 101 may indicate whether the UE is willing to act as a repeater relay for at least one further UE.

In any one of the various embodiments, the transmission of the D2DSS, the D2D discovery and/or the D2D communication performed by a UE may include the transmission and/or reception of messages which takes place over the same interface with which the UE communicates with the RAN.

The signaling used for enabling the UE to transmit the D2DSS and/or for performing a synchronization source reselection may be implemented as layer 1 or layer 2 signaling, for example—

Modifications or alterations may be implemented in other embodiments. For illustration, the UE may receive a signaling which configures the criteria for determining whether the UE is enabled to transmit the D2DSS not only from an eNodeB, but also from another network node of the mobile communication network or from an other UE which acts as a group head of a D2D communication group. The criteria may be fixedly stored in the UE, or fallback criteria may be fixedly stored in the UE for use in case that neither a network node nor a group head can configure the criteria. The parameters used in the various procedures, such as the time interval after which a synchronization source reselection may be performed, may be fixed or may be configured by a network node or a group head, for example.

Embodiments of the invention provide enhanced control over the transmission of a D2DSS by a UE. Unnecessary transmissions of the D2DSS may be reduced wile ensuring that the coverage of the D2DSS will be sufficient for the respective D2D communication needs. The transmission of the D2DSS may be dynamically adapted under the control of a network node or a group head, depending on traffic loads on the air interface or other network parameters, for example. The embodiments also allow holes in the D2DSS coverage to be detected more readily. The battery life of the UE may also be improved by reducing the risk of unnecessary transmissions of the D2DSS.

1. A synchronization method for a device-to-device discovery and/or a device-to-device communication, comprising:
determining, by a user equipment, whether it is enabled to transmit a synchronization signal for the device-to-device discovery and/or the device-to-device communication, the user equipment having a wireless interface configured for communication with a radio access network of a mobile communication network, and
selectively transmitting, by the user equipment, the synchronization signal for the device-to-device discovery and/or the device-to-device communication over the wireless interface to at least one further user equipment.

2. The method of claim 1,
wherein the determining comprises:
evaluating, by the user equipment, whether criteria stored at the user equipment are fulfilled,
wherein the user equipment transmits the synchronization signal for the device-to-device discovery and/or the device-to-device communication depending on a result of the evaluating.

3. The method of claim 2,
wherein evaluating whether the criteria are fulfilled is performed as a fallback procedure when no base station of the mobile communication network is available for requesting, by the user equipment, authorization to transmit the synchronization signal for the device-to-device discovery and/or the device-to-device communication.

4. The method of claim 2,
wherein the user equipment stops transmitting the synchronization signal for the device-to-device discovery and/or the device-to-device communication when the criteria are no longer fulfilled.

5. The method of claim 2, further comprising:
receiving signaling at the wireless interface of the user equipment which configures the criteria.

6. The method of claim 5,
wherein the user equipment receives the signaling which configures the criteria at the user equipment from a base station of the mobile communication network or a group head of a device-to-device communication group.

7. The method of claim 2,
wherein evaluating whether the criteria are fulfilled comprises:
determining whether a signal quality indicator of a device-to-device synchronization signal received at the wireless interface is less than a threshold.

8. The method of claim 2, further comprising:
transmitting, by the user equipment, a request to a base station of the mobile communication network or to a group head of a device-to-device communication group if the criteria are fulfilled, and
receiving, by the user equipment, a message which authorizes the user equipment to transmit the synchronization signal for the device-to-device discovery and/or the device-to-device communication after transmitting the request,
wherein the user equipment transmits the synchronization signal for the device-to-device discovery and/or the device-to-device communication in response to receiving the message.

9. The method of claim 1, further comprising:
transmitting, by the user equipment, a request to a base station of the mobile communication network or to a group head of a device-to-device communication group, the request being transmitted by the user equipment to obtain authorization for relaying at least one of:
data traffic or
the synchronization signal for the device-to-device discovery and/or the device-to-device communication.

10. The method of claim 9, further comprising:
receiving, by the user equipment, a message which authorizes the user equipment to transmit the synchronization signal for the device-to-device discovery and/or the device-to-device communication after transmitting the request,
wherein the user equipment transmits the synchronization signal for the device-to-device discovery and/or the device-to-device communication in response to receiving the message.

11. The method of claim 10, further comprising:
retrieving, by the user equipment, at least one parameter included in the message,
wherein the user equipment selectively transmits the synchronization signal for the device-to-device discovery and/or the device-to-device communication as a function of the at least one parameter.

12. The method of claim 9,
wherein, if no synchronization control unit is available or if the user equipment does not receive a message which authorizes the user equipment to transmit the synchronization signal for the device-to-device discovery and/or the device-to-device communication after transmitting the request, the user equipment evaluates whether criteria stored at the user equipment are fulfilled and transmits the synchronization signal for the device-to-device discovery and/or the device-to-device communication depending on whether the criteria stored at the user equipment are fulfilled.

13. The method of claim 1,
wherein the user equipment is synchronized to a synchronization source, and wherein the method further comprises:
performing a synchronization source reselection by the user equipment.

14. The method of claim 13,
wherein the synchronization source reselection comprises:
identifying, by the user equipment, a further synchronization source which is preferred over the synchronization source based on at least one reselection criterion, said at least one reselection criterion depending on at least one of a priority of the synchronization source, a priority of the further synchronization source, a signal quality of the synchronization source, and a signal quality of the further synchronization source.

15. The method of claim 13,
wherein the synchronization source reselection is performed when a predefined time interval expires.

16. The method of claim 13,
wherein the synchronization source reselection comprises:
receiving a reselection message from a base station of the mobile communication network or from a group head of a device-to-device communication group,
wherein the user equipment performs the synchronization source reselection in response to receiving the reselection message.

17. The method of claim 16,
wherein the synchronization source reselection further comprises:
transmitting, by the user equipment, a reselection request to the base station of the mobile communication network or to the group head of the device-to-device communication group,
wherein the user equipment receives the reselection message in response to transmitting the reselection request.

18. A user equipment, comprising:
a wireless interface configured to communicate with a mobile communication network, and
a processing device coupled to the wireless interface and configured to:
determine whether the user equipment is enabled to transmit a synchronization signal for the device-to-device discovery and/or the device-to-device communication, and
control the wireless interface to selectively transmit the synchronization signal for the device-to-device discovery and/or the device-to-device communication over the wireless interface to at least one further user equipment if the user equipment is enabled to transmit the synchronization signal for the device-to-device discovery and/or the device-to-device communication.

19. (canceled)

20. A synchronization control unit for controlling a transmission of a synchronization signal for a device-to-device discovery and/or a device-to-device communication by a user equipment (2), the synchronization control unit comprising:
a wireless interface configured to communicate with the user equipment, and
a control device coupled to the wireless interface and configured to:
control the wireless interface to enable the user equipment to transmit the synchronization signal for the device-to-device discovery and/or the device-to-device communication.

21. The synchronization control unit of claim 20,
wherein the control device is further configured to:
control the wireless interface to transmit a reselection message to the user equipment to cause the user equipment to perform a synchronization source reselection.

22. A communication system, comprising:
the user equipment of claim 18, and
the synchronization control unit of claim 20.
